(19) United States
(12) Patent Application Publication
(10) Pub. No.: US 2024/0112436 A1
(43) Pub. Date: Apr. 4, 2024

(54) RANKED ADAPTIVE ROI FOR VISION CAMERAS

(71) Applicant: ZEBRA TECHNOLOGIES CORPORATION, Lincolnshire, IL (US)

(72) Inventor: Abhilash Gururaja, Levittown, NY (US)

(21) Appl. No.: 17/958,188

(22) Filed: Sep. 30, 2022

(51) Int. Cl. G06V 10/25; G06K 7/14; G06T 7/73; G06V 10/44

(52) U.S. Cl. CPC G06V 10/25; G06K 7/1443; G06T 7/74; G06V 10/44; G06T 2207/20104

(57) ABSTRACT

Machine vision techniques for determining a region of interest (ROI) are disclosed herein. An example implementation includes a computing device for executing an application, the application operable to: (1) capture a first plurality of images over a field of view (FOV); (2) identify, from the first plurality of images, a plurality of regions of interest (ROIs) within the FOV, each of the plurality of ROIs being ranked based on a recurrence frequency of the visual feature within a predetermined proximity to each of the ROIs within the plurality of images; and (3) successively identifying a candidate location for the visual feature within the second image based on a rank of each of the ROIs, until the visual feature is identified in the candidate location.

### BACKGROUND

It is often useful to locate a visual feature, such as a barcode, on an object. Current vision systems accomplish this by first capturing an image of an object, and then searching a field of view (FOV) of the image (e.g., searching the entire image for the barcode or other object). However, searching the entire image is inefficient. Thus, there is a need for improved efficiency in these types of machine vision systems.

### SUMMARY

In an embodiment, the present invention is a method for operating a machine vision system, the machine vision system including a computing device for executing an application and a fixed imaging device communicatively coupled to the computing device. The method may comprise: (a) capturing, via the fixed imaging device, a first image over a field of view (FOV); (b) analyzing, via the application, at least a portion of the first image to detect a visual feature within the first image; (c) determining, via the application, a location of the visual feature within the first image; (d) determining, via the application, a first region of interest (ROI) within the first image based on the location of the visual feature; (e) capturing, via the fixed imaging device, a second image; (f) analyzing, via the application, at least a portion of the second image to detect the visual feature within the second image; (g) determining, via the application, a location of the visual feature within the second image; (h) determining, via the application, a second ROI within the second image based on the location of the visual feature; (i) ranking the first and second ROIs; (j) capturing, via the fixed imaging device, a third image; (k) analyzing, via the application, a third ROI within the third image to detect the visual feature, the third ROI within the third image being based on the ranking; and (l) responsive to detecting the visual feature in the third image, transmitting data associated with the visual feature in the third image to a host processor.

In a variation of this embodiment, the analyzing the third ROI includes: setting the third ROI to be a higher ranked ROI from the first ROI and the second ROI; if the visual feature is determined not to be within the set third ROI, updating the third ROI to be a lower ranked ROI of the first ROI and the second ROI.

In a further variation of this embodiment, the analyzing the third ROI further includes: if the visual feature is determined not to be within the updated third ROI, setting the third ROI to be a FOV of the third image.

In a further variation of this embodiment, the analyzing the third ROI further includes: analyzing the third ROI that has been set to the FOV of the third image to detect the visual feature; determining, via the application, a location of the visual feature within the third image; determining, via the application, a new third ROI within the third image based on the location of the visual feature; determining, via the application, that the new third ROI is within a predetermined tolerance of the first ROI; and in response to the determination that the new third ROI is within a predetermined tolerance of the first ROI, incrementing, via the application, a weighting factor of the first ROI.

In a further variation of this embodiment, the method further includes: subsequent to the analyzing of the ROI of the third image, iteratively capturing images, and, at each iteration: incrementing a weighting factor of the first ROI if the visual feature is determined to be within the first ROI; incrementing a weighting factor of the second ROI if the visual feature is determined to be within the second ROI; and re-ranking the first and second ROIs based on the weighting factors.

In a further variation of this embodiment: the analyzing the at a portion of the first image to detect the visual feature comprises determining, via the application, a bounding box of the visual feature; and the determining the first ROI within the first image comprises applying a scaling factor to the bounding box.

In a further variation of this embodiment, the method further includes: responsive to detecting the visual feature in the first image, transmitting data associated with the visual feature in the first image to the host processor; and responsive to detecting the visual feature in the second image, transmitting data associated with the visual feature in the second image to the host processor.

In a further variation of this embodiment, the ranking the first and second ROIs comprises: presenting, to a user, a representation of the first ROI and the second ROI; receiving, from the user, a user selection of either the first ROI or the second ROI; and setting the ranks of the first ROI and the second ROI based on the user selection.

In another embodiment, the invention is a method for operating a machine vision system, the machine vision system including a computing device for executing an application and a fixed imaging device communicatively coupled to the computing device. The method may comprise: capturing, via the fixed imaging device, a first plurality of images over a field of view (FOV); from the first plurality of images, identifying, via the application, a plurality of regions of interest (ROIs) within the FOV, each of the plurality of ROIs being associated with a visual feature, each of the plurality of ROIs being ranked based on a recurrence frequency of the visual feature within a predetermined proximity to each of the ROIs within the plurality of images; capturing, via the fixed imaging device, a second image; successively identifying, via the application, a candidate location for the visual feature within the second image based on a rank of each of the ROIs, until the visual feature is identified in the candidate location; and providing data related to the visual feature from the second image to a host processor.

In a variation of this embodiment, the plurality of regions of interest is limited to no more than n ROIs.

In a further variation of this embodiment, n is specified by a user.

In a further variation of this embodiment, the method further comprises: receiving, from a user, input indicating to disable a ROI feature; capturing, via the fixed imaging device, a third image; and in response to receiving the input, setting an ROI within the third image to be the FOV of the third image.

In a further variation of this embodiment, the method further comprises: receiving, from a user, input indicating to disable a ROI feature; capturing, via the fixed imaging device, a third image; setting an ROI within the third image based on a highest ranked ROI of the plurality of ROIs; determining that the feature is not within the ROI within the third image; and in response to receiving the input and determining that the visual feature is not within the ROI within the third image, setting an ROI within the third image to be the FOV of the third image.

In a further variation of this embodiment, the method further comprises: receiving, from a user, input indicating to disable updating rankings; and in response to the input, not updating any recurrence frequency of any ROI of the plurality of ROI upon identification of the visual feature within the second image.

In a further variation of this embodiment, the visual feature is identified in the candidate location based on an entirety of the visual feature being within the candidate location.

In a further variation of this embodiment, the visual feature is identified in the candidate location based on fifty percent or more of the visual feature being within the candidate location.

In a further variation of this embodiment, the method further comprises creating a ranking table including: ranks of each of the plurality of ROIs; the recurrence frequency of the visual feature within a predetermined proximity to each of the plurality of ROIs; and coordinates of each of the plurality of ROIs.

In a further variation of this embodiment, the visual feature is a barcode.

In a further variation of this embodiment, the visual feature is a crack on the surface of a structure.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is an example system for optimizing one or more imaging settings for a machine vision job, in accordance with embodiments described herein.

FIG. 2 is a perspective view of the imaging device of FIG. 1, in accordance with embodiments described herein.

FIG. 3 depicts an example application interface including identification of a single barcode, and where the region of interest (ROI) is the field of view (FOV).

FIG. 4 depicts an example interface including identification of a single barcode, and an ROI set in accordance with embodiments described herein.

FIG. 5 depicts an example interface including identification of multiple barcodes, and where the ROI is the FOV.

FIG. 6 depicts an example interface including identification of multiple barcodes, and an ROI set in accordance with embodiments described herein.

FIG. 7 illustrates an example method of identifying a visual feature in a barcode, including capturing a first plurality of images, according to an embodiment.

FIG. 8 illustrates an example ranking table.

FIG. 9 illustrates an example method of identifying a visual feature in a barcode, according to an embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

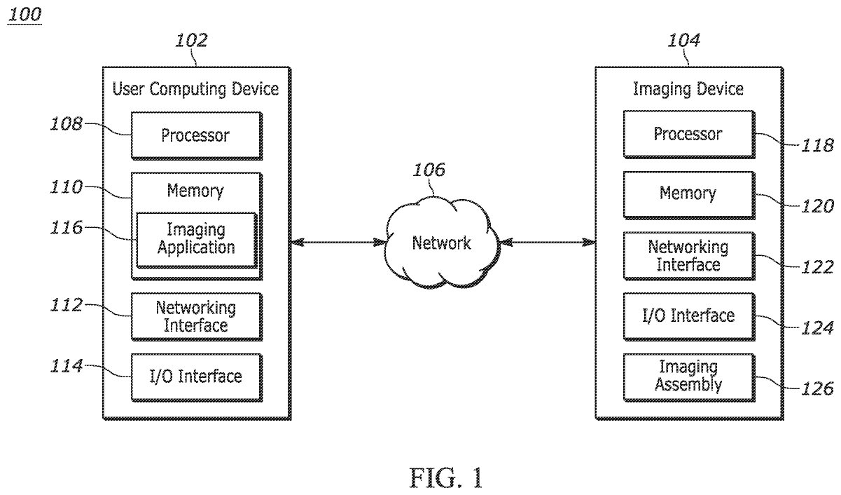

Broadly speaking, some embodiments described herein use ranking-based adaptive ROI techniques to find visual feature(s) in an image. For example, by way of reference to FIG. 1, an imaging device 104 may capture images, which it sends to the user computing device 102. The imaging application 116 may then use the images to rank ROIs of the images (e.g., based on a recurrence frequency of the visual feature being within the ROI, or based on any other suitable technique). The imaging application 116 may then receive additional images, and then search the additional images for the visual feature within the highest ranked ROI. If the visual feature is not found within the highest ranked ROI, the imaging application 116 may search for the visual feature within the second highest ranked ROI, and so forth, until the visual feature is found. If the visual feature is not found within any of the ROIs, the imaging application may set the ROI to be the FOV of the new image (e.g., as a fallback mechanism) so that the imaging application 116 effectively searches the entire new image (e.g., at full resolution) for the visual feature.

More specifically, FIG. 1 illustrates an example imaging system 100 configured to locate a barcode or other object. In the example embodiment of FIG. 1, the imaging system 100 includes a user computing device 102 and an imaging device 104 communicatively coupled to the user computing device 102 via a network 106. Generally speaking, the user computing device 102 is configured to enable a user/operator to create a machine vision job for execution on the imaging device 104. Once created, the user/operator may then transmit/upload the machine vision job to the imaging device 104 via the network 106, where the machine vision job is then interpreted and executed. The user computing device 102 may comprise one or more operator workstations, and may include one or more processors 108, one or more memories 110, a networking interface 112, an input/output interface 114, and a imaging application 116.

The imaging device 104 is connected to the user computing device 102 via a network 106, and is configured to interpret and execute machine vision jobs received from the user computing device 102. Generally, the imaging device 104 may obtain, from the user computing device 102 and through the network 106, a job file containing one or more job scripts that may define the machine vision job and may configure the imaging device 104 to capture and/or analyze images in accordance with the machine vision job. For example, the imaging device 104 may include flash memory used for determining, storing, or otherwise processing imaging data/datasets and/or post-imaging data. The imaging device 104 may then receive, recognize, and/or otherwise interpret a trigger that causes the imaging device 104 to capture an image of the target object in accordance with the configuration established via the one or more job scripts. Once captured and/or analyzed, the imaging device 104 may transmit the images and any associated data across the network 106 to the user computing device 102 for further analysis and/or storage. In various embodiments, the imaging device 104 may be a “smart” camera and/or may otherwise be configured to automatically perform sufficient functionality of the imaging device 104 in order to obtain, interpret, and execute job scripts that define machine vision jobs, such as any one or more job scripts contained in one or more job files as obtained, for example, from the user computing device 102.

Broadly, the job file may be a JSON representation/data format of the one or more job scripts transferrable from the user computing device 102 to the imaging device 104. The job file may further be loadable/readable by a C++ runtime engine, or other suitable runtime engine, executing on the imaging device 104. Moreover, the imaging device 104 may run a server (not shown) configured to listen for and receive job files across the network 106 from the user computing device 102. Additionally or alternatively, the server configured to listen for and receive job files may be implemented as one or more cloud-based servers, such as a cloud-based computing platform. For example, the server may be any one or more cloud-based platform(s) such as MICROSOFT AZURE, AMAZON AWS, or the like.

In any event, the imaging device 104 may include one or more processors 118, one or more memories 120, a networking interface 122, and input/output interface 124, and an imaging assembly 126. The imaging assembly 126 may include a digital camera and/or digital video camera for capturing or taking digital images and/or frames. Each digital image may comprise pixel data that may be analyzed by one or more tools each configured to perform an image analysis task, as described herein. The digital camera and/or digital video camera of, e.g., the imaging assembly 126 may be configured to take, capture, or otherwise generate digital images and, at least in some embodiments, may store such images in a memory (e.g., one or more memories 110, 120) of a respective device (e.g., user computing device 102, imaging device 104).

For example, the imaging assembly 126 may include a photo-realistic camera (not shown) for capturing, sensing, or scanning 2D image data. The photo-realistic camera may be an RGB (red, green, blue) based camera for capturing 2D images having RGB-based pixel data. In various embodiments, the imaging assembly may additionally include a three-dimensional (3D) camera (not shown) for capturing, sensing, or scanning 3D image data. The 3D camera may include an Infra-Red (IR) projector and a related IR camera for capturing, sensing, or scanning 3D image data/datasets. In some embodiments, the photo-realistic camera of the imaging assembly 126 may capture 2D images, and related 2D image data, at the same or similar point in time as the 3D camera of the imaging assembly 126 such that the imaging device 104 can have both sets of 3D image data and 2D image data available for a particular surface, object, area, or scene at the same or similar instance in time. In various embodiments, the imaging assembly 126 may include the 3D camera and the photo-realistic camera as a single imaging apparatus configured to capture 3D depth image data simultaneously with 2D image data. Consequently, the captured 2D images and the corresponding 2D image data may be depth-aligned with the 3D images and 3D image data.

The entire area that the imaging device 104 is able to image may be referred to as the field of view (FOV). In this regard, the FOV is determined by the optics of the imaging device 104. Typically, the imaging device 104 may capture images of the environment appearing within the FOV. When analyzing the image, certain parts of the image may be identified with respect to pixel values, and/or certain coordinates of the image (e.g., horizontal and vertical pixel values, a Cartesian coordinate system including pixel values, etc.).

As mentioned above, the pixel data may be analyzed by one or more tools each configured to perform an image analysis task. For example, a barcode scanning/reading tool may be executed to detect or read a barcode. To this end, it may be useful to define a region of interest (ROI) corresponding to a specific region or a target object imaged by the imaging assembly 126 within which to execute the tool (e.g., to execute the barcode scanning/reading tool). In this regard, and as will become apparent from the following discussion, determining an ROI may be done as part of execution of a tool (e.g., execution of the barcode scanning/reading tool). Additionally or alternatively, determining a ROI may be done specifically with a ROI specification/determination tool.

To further explain the job and the corresponding tools of the job, generally, the imaging application 116 may present a user with a series of menus to create a new job or edit a current job. In creating a new job, the user is able to select from a variety of tools which form a particular job. Such tools may include, but are not limited to, (i) a barcode scanning/reading tool, (ii) a pattern matching tool, (iii) an edge detection tool, (iv) a semantic segmentation tool, (v) an object detection tool, (vi) an object tracking tool, (vii) a region of interest specification/determination tool, etc. For example, if a first type of product is running down an assembly line, a user may configure a first job, including selecting and configuring particular tools, to run (e.g., continuously or iteratively capturing images) while the first type of product is running through the assembly line. Subsequently, when the assembly line switches to a second type of product, the user may end the first job and start a second job by configuring the second job, including selecting and configuring different tools that are more helpful to analyze the second type of product.

The imaging device 104 may also process the 2D image data/datasets and/or 3D image datasets for use by other devices (e.g., the user computing device 102, an external server). For example, the one or more processors 118 may process the image data or datasets captured, scanned, or sensed by the imaging assembly 126. The processing of the image data may generate post-imaging data that may include metadata, simplified data, normalized data, result data, status data, or alert data as determined from the original scanned or sensed image data. The image data and/or the post-imaging data may be sent to the user computing device 102 executing the imaging application 116 for viewing, manipulation, and/or otherwise interaction. In other embodiments, the image data and/or the post-imaging data may be sent to a server for storage or for further manipulation. As described herein, the user computing device 102, imaging device 104, and/or external server or other centralized processing unit and/or storage may store such data, and may also send the image data and/or the post-imaging data to another application implemented on a user device, such as a mobile device, a tablet, a handheld device, or a desktop device.

Each of the one or more memories 110, 120 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. In general, a computer program or computer based product, application, or code (e.g., imaging application 116, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the one or more processors 108, 118 (e.g., working in connection with the respective operating system in the one or more memories 110, 120) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

The one or more memories 110, 120 may store an operating system (OS) (e.g., Microsoft Windows, Linux, Unix, etc.) capable of facilitating the functionalities, apps, methods, or other software as discussed herein. The one or more memories 110 may also store the imaging application 116, which may be configured to enable machine vision job construction, as described further herein. Additionally, or alternatively, the imaging application 116 may also be stored in the one or more memories 120 of the imaging device 104, and/or in an external database (not shown), which is accessible or otherwise communicatively coupled to the user computing device 102 via the network 106. The one or more memories 110, 120 may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For example, at least some of the applications, software components, or APIs may be, include, otherwise be part of, a machine vision based imaging application, such as the imaging application 116, where each may be configured to facilitate their various functionalities discussed herein. It should be appreciated that one or more other applications may be envisioned and that are executed by the one or more processors 108, 118.

The one or more processors 108, 118 may be connected to the one or more memories 110, 120 via a computer bus responsible for transmitting electronic data, data packets, or otherwise electronic signals to and from the one or more processors 108, 118 and one or more memories 110, 120 in order to implement or perform the machine readable instructions, methods, processes, elements or limitations, as illustrated, depicted, or described for the various flowcharts, illustrations, diagrams, figures, and/or other disclosure herein.

The one or more processors 108, 118 may interface with the one or more memories 110, 120 via the computer bus to execute the operating system (OS). The one or more processors 108, 118 may also interface with the one or more memories 110, 120 via the computer bus to create, read, update, delete, or otherwise access or interact with the data stored in the one or more memories 110, 120 and/or external databases (e.g., a relational database, such as Oracle, DB2, MySQL, or a NoSQL based database, such as MongoDB). The data stored in the one or more memories 110, 120 and/or an external database may include all or part of any of the data or information described herein, including, for example, machine vision job images (e.g., images captured by the imaging device 104 in response to execution of a job script) and/or other suitable information.

The networking interfaces 112, 122 may be configured to communicate (e.g., send and receive) data via one or more external/network port(s) to one or more networks or local terminals, such as network 106, described herein. In some embodiments, networking interfaces 112, 122 may include a client-server platform technology such as ASP.NET, Java J2EE, Ruby on Rails, Node.js, a web service or online API, responsive for receiving and responding to electronic requests. The networking interfaces 112, 122 may implement the client-server platform technology that may interact, via the computer bus, with the one or more memories 110, 120 (including the applications(s), component(s), API(s), data, etc. stored therein) to implement or perform the machine readable instructions, methods, processes, elements or limitations, as illustrated, depicted, or described for the various flowcharts, illustrations, diagrams, figures, and/or other disclosure herein.

According to some embodiments, the networking interfaces 112, 122 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to network 106. In some embodiments, network 106 may comprise a private network or local area network (LAN). Additionally or alternatively, network 106 may comprise a public network such as the Internet. In some embodiments, the network 106 may comprise routers, wireless switches, or other such wireless connection points communicating to the user computing device 102 and the imaging device 104 via wireless communications based on any one or more of various wireless standards, including by non-limiting example, IEEE 802.11a/b/c/g (WIFI), the BLUETOOTH standard, or the like.

The input/output interfaces 114, 124 may include or implement operator interfaces configured to present information to an administrator or operator and/or receive inputs from the administrator or operator. An operator interface may provide a display screen (e.g., via the user computing device 102 and/or imaging device 104) which a user/operator may use to visualize any images, graphics, text, data, features, pixels, and/or other suitable visualizations or information. For example, the user computing device 102 and/or imaging device 104 may comprise, implement, have access to, render, or otherwise expose, at least in part, a graphical user interface (GUI) for displaying images, graphics, text, data, features, pixels, and/or other suitable visualizations or information on the display screen. The input/output interfaces 114, 124 may also include input/output components (e.g., ports, capacitive or resistive touch sensitive input panels, keys, buttons, lights, LEDs), which may be directly/indirectly accessible via or attached to the user computing device 102 and/or the imaging device 104. According to some embodiments, an administrator or user/operator may access the user computing device 102 and/or imaging device 104 to construct jobs, review images or other information, make changes, input responses and/or selections, and/or perform other functions.

As described above herein, in some embodiments, the user computing device 102 may perform the functionalities as discussed herein as part of a “cloud” network or may otherwise communicate with other hardware or software components within the cloud to send, retrieve, or otherwise analyze data or information described herein.

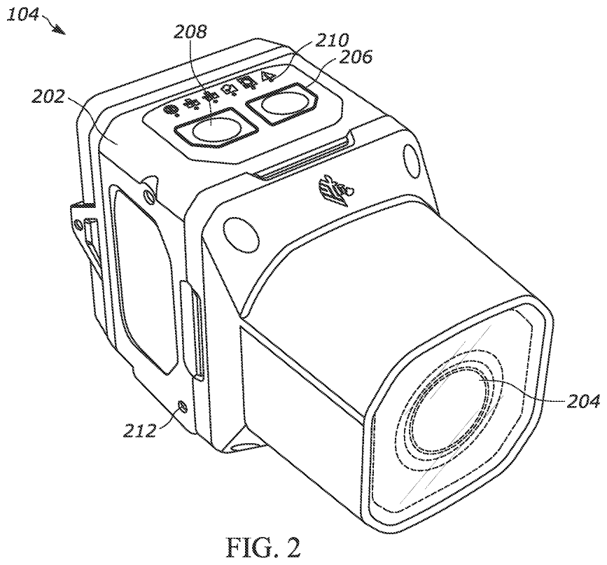

FIG. 2 is a perspective view of the imaging device 104 of FIG. 1, in accordance with embodiments described herein. The imaging device 104 includes a housing 202, an imaging aperture 204, a user interface label 206, a dome switch/button 208, one or more light emitting diodes (LEDs) 210, and mounting point(s) 212. As previously mentioned, the imaging device 104 may obtain job files from a user computing device (e.g., user computing device 102) which the imaging device 104 thereafter interprets and executes. The instructions included in the job file may include device configuration settings (also referenced herein as “imaging settings”) operable to adjust the configuration of the imaging device 104 prior to capturing images of a target object.

For example, the device configuration settings may include instructions to adjust one or more settings related to the imaging aperture 204. As an example, assume that at least a portion of the intended analysis corresponding to a machine vision job requires the imaging device 104 to maximize the brightness of any captured image. To accommodate this requirement, the job file may include device configuration settings to increase the aperture size of the imaging aperture 204. The imaging device 104 may interpret these instructions (e.g., via one or more processors 118) and accordingly increase the aperture size of the imaging aperture 204. Thus, the imaging device 104 may be configured to automatically adjust its own configuration to optimally conform to a particular machine vision job. Additionally, the imaging device 104 may include or otherwise be adaptable to include, for example but without limitation, one or more bandpass filters, one or more polarizers, one or more DPM diffusers, one or more C-mount lenses, and/or one or more C-mount liquid lenses over or otherwise influencing the received illumination through the imaging aperture 204.

The user interface label 206 may include the dome switch/button 208 and one or more LEDs 210, and may thereby enable a variety of interactive and/or indicative features. Generally, the user interface label 206 may enable a user to trigger and/or tune to the imaging device 104 (e.g., via the dome switch/button 208) and to recognize when one or more functions, errors, and/or other actions have been performed or taken place with respect to the imaging device 104 (e.g., via the one or more LEDs 210). For example, the trigger function of a dome switch/button (e.g., dome/switch button 208) may enable a user to capture an image using the imaging device 104 and/or to display a trigger configuration screen of a user application (e.g., imaging application 116). The trigger configuration screen may allow the user to configure one or more triggers for the imaging device 104 that may be stored in memory (e.g., one or more memories 110, 120) for use in later developed machine vision jobs, as discussed herein.

As another example, the tuning function of a dome switch/button (e.g., dome/switch button 208) may enable a user to automatically and/or manually adjust the configuration of the imaging device 104 in accordance with a preferred/predetermined configuration and/or to display an imaging configuration screen of a user application (e.g., imaging application 116). The imaging configuration screen may allow the user to configure one or more configurations of the imaging device 104 (e.g., aperture size, exposure length, etc.) that may be stored in memory (e.g., one or more memories 110, 120) for use in later developed machine vision jobs, as discussed herein.

To further this example, and as discussed further herein, a user may utilize the imaging configuration screen (or more generally, the imaging application 116, 156) to establish two or more configurations of imaging settings for the imaging device 104. The user may then save these two or more configurations of imaging settings as part of a machine vision job that is then transmitted to the imaging device 104 in a job file containing one or more job scripts. The one or more job scripts may then instruct the imaging device 104 processors (e.g., one or more processors 118) to automatically and sequentially adjust the imaging settings of the imaging device in accordance with one or more of the two or more configurations of imaging settings after each successive image capture.

The mounting point(s) 212 may enable a user connecting and/or removably affixing the imaging device 104 to a mounting device (e.g., imaging tripod, camera mount, etc.), a structural surface (e.g., a warehouse wall, a warehouse ceiling, structural support beam, etc.), other accessory items, and/or any other suitable connecting devices, structures, or surfaces. For example, the imaging device 104 may be optimally placed on a mounting device in a distribution center, manufacturing plant, warehouse, and/or other facility to image and thereby monitor the quality/consistency of products, packages, and/or other items as they pass through the imaging device's 104 FOV. Moreover, the mounting point(s) 212 may enable a user to connect the imaging device 104 to a myriad of accessory items including, but without limitation, one or more external illumination devices, one or more mounting devices/brackets, and the like.

In addition, the imaging device 104 may include several hardware components contained within the housing 202 that enable connectivity to a computer network (e.g., network 106). For example, the imaging device 104 may include a networking interface (e.g., networking interface 122) that enables the imaging device 104 to connect to a network, such as a Gigabit Ethernet connection and/or a Dual Gigabit Ethernet connection. Further, the imaging device 104 may include transceivers and/or other communication components as part of the networking interface to communicate with other devices (e.g., the user computing device 102) via, for example, Ethernet/IP, PROFINET, Modbus TCP, CC-Link, USB 3.0, RS-232, and/or any other suitable communication protocol or combinations thereof.

One application of the above described technologies is to identify one or more barcodes (or other visual features, such as a crack(s) on the surface of a structure) within an image. Current techniques for identifying barcode(s) in images include searching an entire field of view (FOV) of an image. However, this is inefficient because the barcode(s) may be located in only one portion of the image. Thus, some embodiments set an ROI to be only part of the FOV, and search only the ROI.

It should be understood that the term “image” as used herein may refer to a single image, or to an image of a video frame. Thus, the techniques described herein apply equally to single images and video.

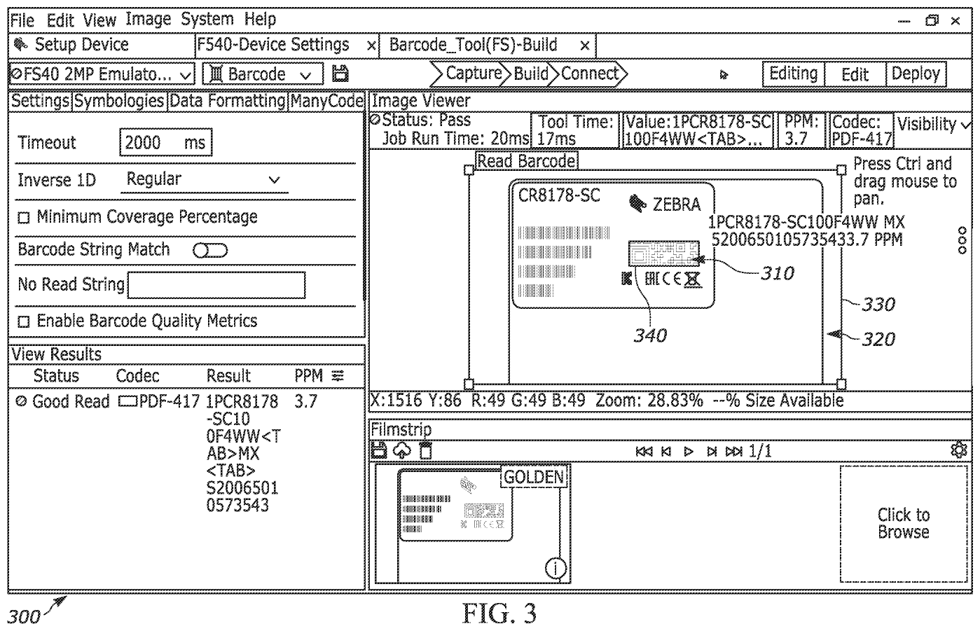

FIGS. 3-6 depict example application interfaces in accordance with embodiments described herein. These example application interfaces 300, 400, 500, 600 may represent interfaces of a imaging application (e.g., imaging application 116) a user may access via a user computing device (e.g., user computing device 102).

In FIG. 3, the example application interface 300 depicts identification of a single barcode 310, and where the region of interest (ROI) 330 is the field of view (FOV) 320 (e.g., the entire image). In this regard, in some embodiments, the default ROI is the FOV. Further in this example, the imaging application 116 has determined a bounding box 340 of the barcode 310.

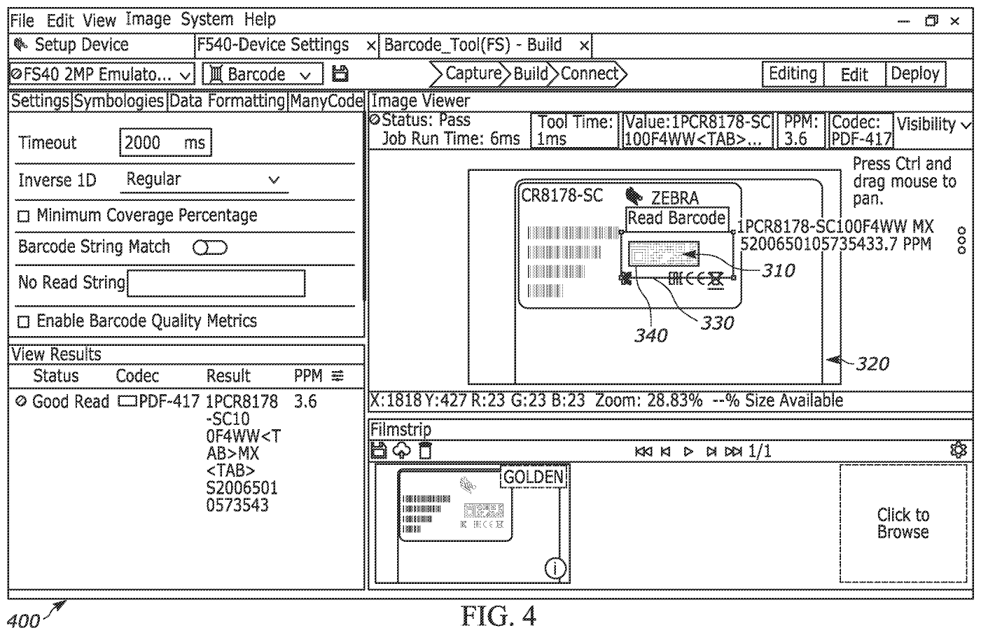

In FIG. 4, the example application interface 400 likewise depicts identification of a single barcode 310. However, in contrast to the example of FIG. 3, the ROI 330 has been set to a smaller portion of the image (e.g., not the entire FOV 320), thus saving time and processing power in searching the image.

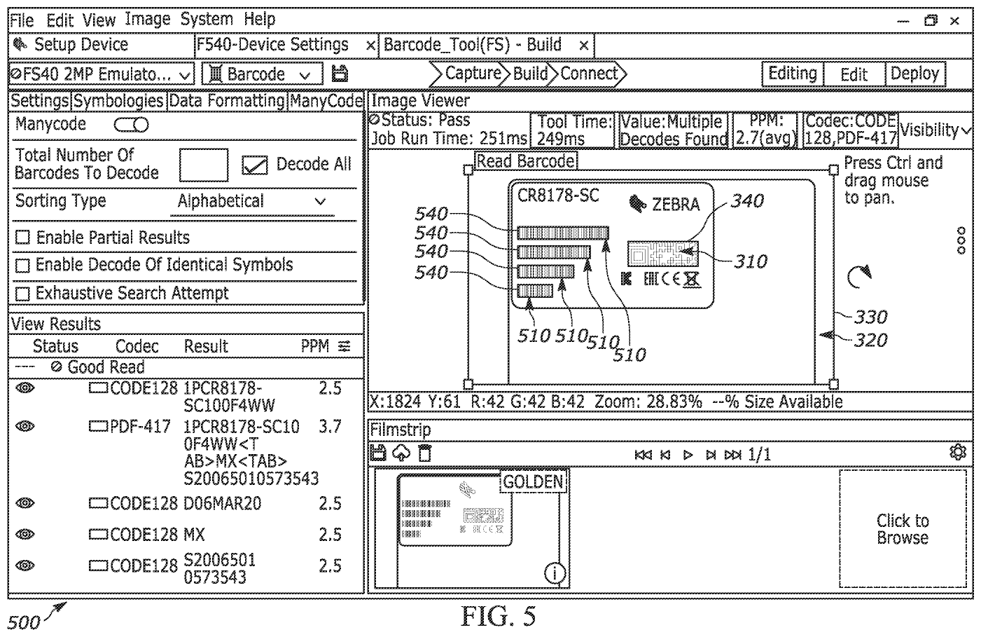

In FIG. 5, the example application interface 500 depicts identification of barcode 310, as well as identification of additional barcodes 510. In the example of FIG. 5, the ROI 330 has been set to the FOV 320 (e.g., the entire image); and bounding boxes 540 have been drawn around the barcodes 510.

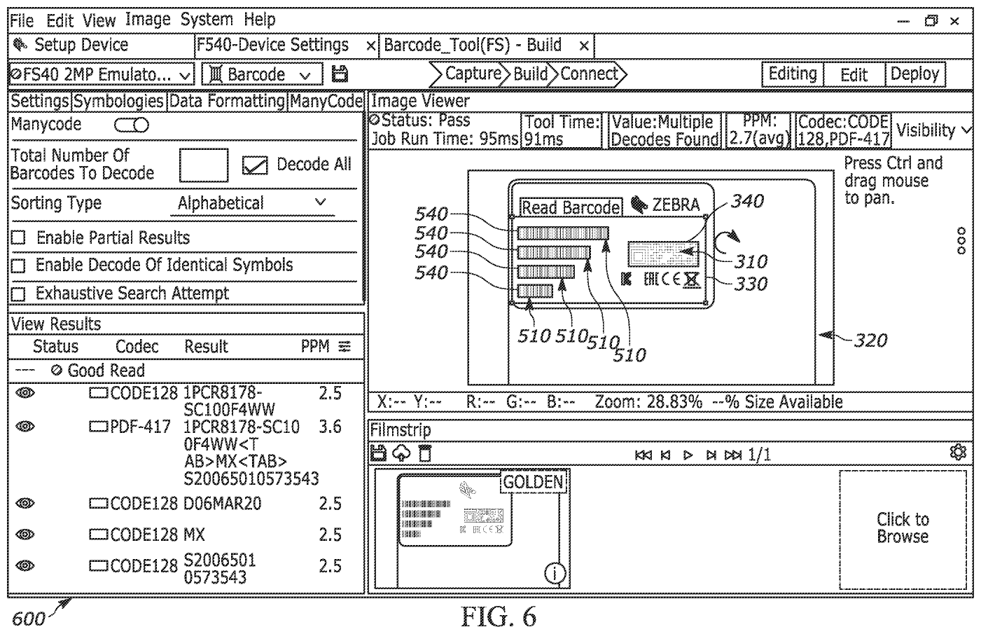

In FIG. 6, the example application interface 600 also depicts identification of barcode 310, as well as identification of additional barcodes 510. However, in contrast to the example of FIG. 5, the ROI 330 has been set to a smaller portion of the image (e.g., not the entire FOV 320), thus saving time and processing power in searching the image. The example of FIG. 6 also illustrates bounding boxes 540 drawn around the barcodes 510.

Further regarding the examples of FIGS. 3-6, although the illustrated example ROIs 330, are rectangular, the ROI may be any shape. For example, the ROI may be a rectangle, a triangle, a pentagon, or a polygon with n-sides, etc. Additionally or alternatively, the ROI may be specified to be a percentage of the FOV (e.g., 50% of the FOV). Additionally or alternatively, a user (e.g., via the user computing device 102) may manually set a ROI by drawing a particular shape, or by specifying a set of parameters.

Generally speaking, some embodiments described herein use ranking-based adaptive ROI techniques to help find visual feature(s) in an image. For example, the imaging application 116 may have data of a plurality of ROIs that it has used in past iterations of a job, or in past jobs. The imaging application 116 may rank the ROIs (e.g., based on a recurrence frequency of the visual feature being within the ROI, or based on any other suitable technique). The imaging application 116 may receive a new image, and then search for the visual feature within the highest ranked ROI. If the visual feature is not found within the highest ranked ROI, the imaging application 116 may search for the visual feature within the second highest ranked ROI, and so forth, until the visual feature is found. If the visual feature is not found within any of the ROIs, the imaging application may set the ROI to be the FOV of the new image so that the imaging application 116 effectively searches the entire new image for the visual feature.

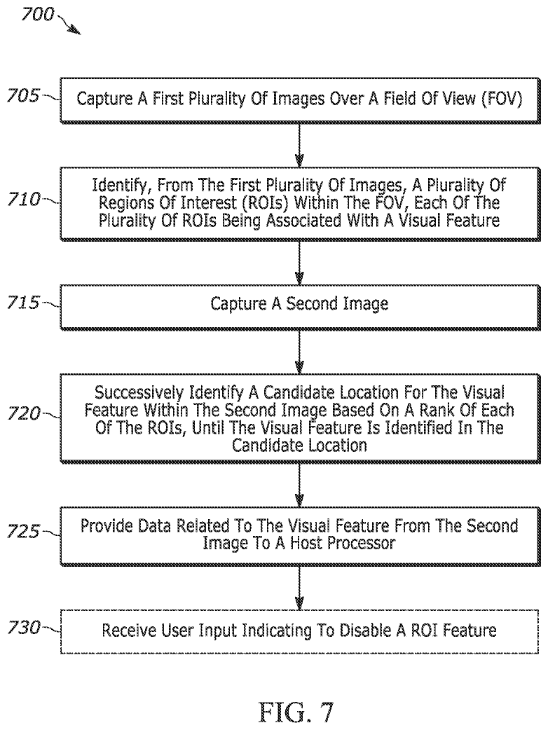

FIG. 7 illustrates an example method 700 of identifying a visual feature in a barcode. At block 705, the imaging device 104 captures a first plurality of images. The images may be sequential images, or there may be intervening images between the images. For example, the images may be in a video stream, and separated by a predefined time period. It should be understood that a user (e.g., via the user computing device 102) may customize how the images are captured (e.g., set a time period between image capture, etc.).

At block 710, a plurality of ROIs are identified from the first plurality of images. Each of the plurality of ROIs may be associated with a visual feature (e.g., a barcode, a crack in the surface of a structure, etc.).

In some embodiments, one or more of the ROIs (e.g., an ROI in the very first image received) may be identified by searching the FOV of the image for the visual feature. Once the visual feature is found, a bounding box (e.g., 340) may be drawn around the visual feature (e.g., 310, 510). A scaling factor (e.g., 10%, 20%, 50%, 100%, 500%, 1,000%, etc.) may then be applied to the bounding box to determine the ROI. For example, if the scaling factor is 100%, each side of the bounding box may be expanded by 100% to form the ROI. A user may set the scaling factor in the system. Further regarding the bounding boxes, in some embodiments the bounding box encompasses exactly the visual feature. In other embodiments, the bounding box encompasses the visual feature as well as a small area outside of the visual feature. For example, the bounding box may encompass the visual feature, as well as an area extending 10% by length beyond of each of the sides of the visual feature.

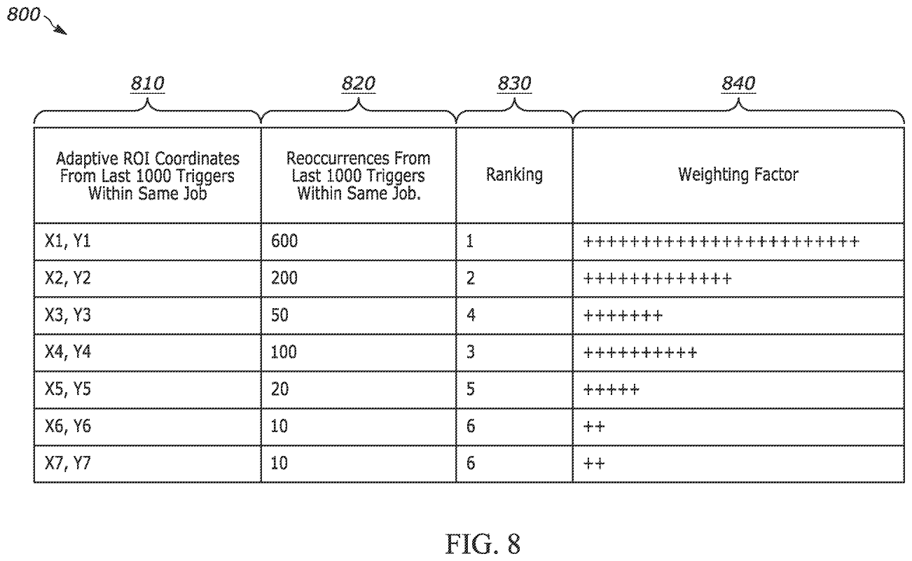

Furthermore, each of the ROIs may be ranked. For example, a particular ROI may be applied to multiple images, and evaluated to determine if the visual feature is found within the particular ROI, thereby generating a recurrence count and/or recurrence frequency for the visual feature within the particular ROI. Thus, rankings may be created based on the recurrence count and/or recurrence frequency. For instance, an ROI with the highest recurrence frequency may have the highest rank, an ROI with the second highest recurrence frequency may have the second highest rank, and so on. In the event of a tie between recurrence frequencies, any suitable technique may be used to resolve the tie. For example, the most recent ROI that has had the visual feature found within it may be ranked higher to resolve the tie. In another example, the two ROIs with the same recurrence frequency may be given the same rank (e.g., rank 5 out of 10 ROIs), but the ROI with the more recent find of a visual feature may be applied first when searching new images (e.g., as will be described further with respect to the last two rows of the example ranking table 800 of FIG. 8).

In some embodiments, the recurrence frequency is based on the entire visual feature being within the ROI. However, in other embodiments, the recurrence frequency is based on more than a certain percentage (e.g., 50%, 75%, 90%, etc.) of the visual feature being within the ROI, or the visual feature being inside of the ROI by a particular margin. In this regard, the recurrence frequency may be based on the visual feature being within a predetermined proximity to the ROI. The percentage that the visual feature must be inside of the ROI by, or the particular margin that the visual feature must be inside the ROI by may be set by a user.

In addition, the recurrence frequency may be a recurrence frequency within the same job or different jobs. For example, when starting a new job, a user may optionally select to have data (e.g., a ranking table, such as the example ranking table 800) imported from a previous job so that the new job will start with a ranking system including ranked ROIs from the previous job.

Additionally or alternatively, the recurrence frequency may be for a previous number of images analyzed (e.g., the last 1,000 images analyzed), or for a previous number of triggers (e.g., a trigger being an occurrence of the visual feature being found within an image).

The rankings may be recorded in a ranking table, such as the example ranking table 800 of FIG. 8. In the illustrated example, column 810 identifies the ROI according to coordinates. In the illustrated example, only one coordinate is given to identify the ROI. This may be any suitable coordinate to identify the ROI, such as the coordinate of a corner of the ROI (e.g., the upper left corner, etc.), the coordinate of a center of the ROI, etc. However, in other examples, the ranking table may list more than one coordinate (e.g., the coordinates of all four corners, etc.) to identify the ROI.

Column 820 illustrates the number of recurrences (e.g., of the visual feature being within the ROI, or being within a predetermined proximity to the ROI). It should be understood that the recurrence frequency is simply the number of recurrences divided by the last number of total triggers; for example, for the ROI with coordinates of X1, Y1 in the example of FIG. 8, the recurrence frequency is 600/1000. Column 830 illustrates the ranking of the ROI.

To facilitate the ranking process, some embodiments include a weighting factor, such as in the example of column 840. For example, the ROIs may be ranked in whole or in part based on the weighting factor. In some implementations, the weighting factor may be incremented each time the visual feature is found within the ROI or within a predetermined proximity to the ROI. In other examples, the weighting factor may be incremented when the visual feature is found a predetermined number of times (e.g., five times) within the ROI, or within a predetermined proximity to the ROI. In one such example, the ranks are based first on the weighting factor, and then use the recurrence count to resolve ties between the weighting factors.

Furthermore, in some cases, the visual feature may be found more than once in each ROI. For instance, in the examples of FIGS. 5-6, more than one barcode 510 may be found (e.g., within the ROI or within a predetermined proximity to the ROI). In some embodiments, when more than one of the visual feature is found within the ROI, the number of recurrences (e.g., in column 820) is still increased as if the visual had been found only once (e.g., the number in column 820 is increased at most once per image no matter how many times the visual feature is found). However, in other embodiments, the number of reoccurrences is increased based on the number of times the visual feature was found in the ROI (e.g., once for each time the visual feature is found). In addition, in some embodiments, the weighting factor may be increased based on the number of times that visual feature is found within the ROI (e.g., weighting factor is incremented once if the visual feature is found twice within the ROI).

Returning to the example of FIG. 7, at block 715, the imaging device 104 captures a second image. It may be noted that the second image may be one of the images of the first plurality of images, or an image that is not part of the first plurality of images.

At block 720, the imaging application 116 successively identifies a candidate location (e.g., an ROI) for the visual feature within the second image based on a rank of each of the ROIs, until the visual feature is identified in the candidate location. For example, the first candidate location may be the highest ranked ROI. If the visual feature is not found within the first ROI, the next candidate location (e.g., the next highest ranked ROI) may be searched until the visual feature is found. In some embodiments, the number of candidate locations (e.g., ROIs) searched, n, may be set by the user.

At block 725, data related to the visual feature may be provided to a host processor, such as processor 108. The data related to the visual feature may be any data. Examples of the data include: data of a decoded barcode, image data of the ROI that the visual feature was located in, etc.

Following block 725, the process may optionally continue to iterate. For example, the process may capture a third image, and apply the ranked ROI techniques described herein to identify a visual feature within the third image. However, additionally or alternatively, at optional block 730, the imaging application 116 may receive input indicating to disable a ROI feature (e.g., continue to run the job, but with a particular ROI feature disabled). In one example, the user may choose to disable all adaptive ROI features. In this example, following receipt of the user input, the imaging application 116 may analyze the FOV, rather than an ROI from the ranked ROIs, to find the visual feature. In another example, the user may partially disable the adaptive ROI features. In one such example, the imaging application 116 may first search the highest ranked ROI for the visual feature; but, if the visual feature is not found within the highest ranked ROI, the imaging application then searches the FOV rather than iterating through the rest of the ranked ROIs.

In yet another example, the user may disable updating the rankings (e.g., suspend the updating of the rankings). For example, a third image received may be analyzed according to the ranked ROIs, but no updates to any ranking table, such as the example ranking table 800, are made.

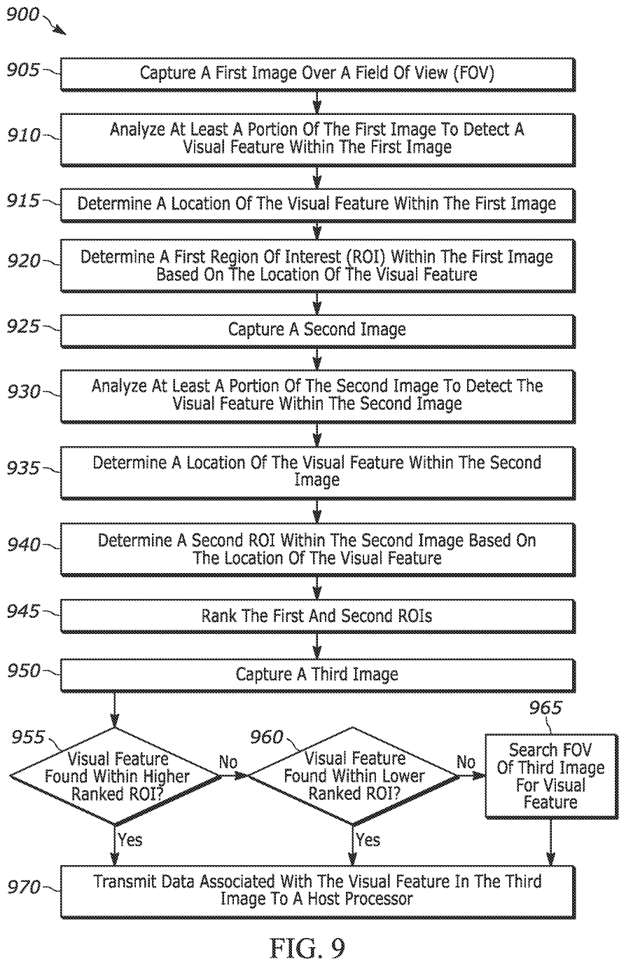

FIG. 9. shows an additional example method 900, including receiving a first image. The example method 900 begins at block 905 when the imaging device 104 captures a first image over a FOV. The imaging application 166 may then, at block 910, analyze at least a portion of the first image to detect a visual feature within the first image.

In some embodiments, where the visual feature is a barcode, the imaging application 116 detects the barcode by the imaging application 116 being able to decode the barcode. However, it should be noted that the barcode does not necessarily have to be decoded for its presence to be detected. Furthermore, it should be understood that “barcode” as referred to herein also refers to effective equivalents of a barcode, such as a quick response (QR) code or other information marker.

Further at block 910, in embodiments where the system has access to prior data, such as a ranking table, the analyzed at least a portion of the first image may be a highest ranked ROI. However, in embodiments where the system has no access to such prior data, the analyzed at least a portion of the first image may be the FOV of the first image; and the first ROI may be built as described below, particularly with respect to block 920.

At block 915, the imaging application 116 may determine a location of the visual feature within the first image. At block 920, the imaging application 116 may then determine a first ROI within the first image. In some embodiments, the determination is made based on the location of the visual feature. For example, the imaging application 116 may place a bounding box around the visual feature, and then apply a scaling factor (e.g., 10%, 20%, 50%, 100%, 500%, 1,000%, etc.) to the bounding box to create/determine the ROI.

In some embodiments, rather than the imaging application 116 automatically determining the first ROI, a user (e.g., via the user computing device 102) may manually set the first ROI by drawing a particular shape (e.g., onto a display displaying the first image), or by specifying a set of parameters, such as a shape of the ROI (e.g., a rectangle, a triangle, a pentagon, or a polygon with n-sides, etc.) or size of the ROI (e.g., ROI is 50% of the FOV).

At block 925, the imaging device 104 captures a second image. At block 930, the imaging application 116 analyzes at least a portion of the second image to detect the visual feature within the second image. At block 935, the imaging application 116 determines a location of the visual feature within the second image. At block 940, the imaging application 116 may then determine a second ROI within the second image. In some embodiments, the determination is made based on the location of the visual feature. For example, the imaging application 116 may place a bounding box around the visual feature, and then apply a scaling factor (e.g., either the same or different scaling factor that may have been applied to the visual feature within the first image) to the bounding box to create/determine the ROI.

However, in some embodiments, optionally at block 930, the analyzed at least a portion of the second image comprises the first ROI (e.g., determined at block 920) (rather than, e.g., the FOV of the second image). In some such embodiments, if the visual feature is not found within the first ROI, the imaging application 116 may search other ROIs (if there are any from prior data), e.g., in accordance with the ranking techniques described herein, and until the visual feature is found.

At block 945, the imaging application 116 ranks the first and second ROIs. The first and second ROIs may be ranked by any suitable technique, such as based on recurrence frequencies and/or weighting factors, as described above. For example, if there is previously acquired data, the imaging application may match (e.g., an exact match, or within a predetermined tolerance) the first and/or second ROIs to previously known ROIs (e.g., listed in ranking table 800), and update the rankings in the ranking table 800 to thereby rank the first and second ROIs. In another example, if there is no previously acquired data, and the visual feature was found once in each of the first and second images, there may be a tie between recurrence frequencies; in this case, the tie may be resolved, as described above. In yet another example, the ranking may be accomplished by presenting a user with depictions of the first and second ROIs, and receiving a selection from the user of an ROI.

At block 950, the imaging device 104 captures a third image. At block 955, the imaging application 116 searches the higher ranked of the first and second ROI find the visual feature (e.g., find within the ROI or find within a predetermined proximity to the ROI). If the visual feature is not found, the imaging application 116 searches the lower ranked of the first and second ROIs for the visual feature at decision block 960. If the visual feature is not found at block 960, the imaging application 116 searches the FOV of the third image for the visual feature at block 965.

Furthermore, alternatively following block 960 if the visual feature is not found, the imaging application 116 may instead continue to iterate through lower ranked ROIs (e.g., in embodiments where the system has access to prior data, such as a ranking table, etc., to provide the lower ranked ROIs) until the visual feature is found, or until the visual feature is not found in any ROI so that the FOV is then searched. In some such embodiments, the user may control (e.g., though a setting) how many ROIs are iterated though before switching to the FOV if the visual feature is not found in any of those ROIs.

Once the visual feature has been found, data associated with the visual feature may be transmitted to a host processor (e.g., at block 970), such as the one or more processors 118. However, it should be noted that any data may be transmitted to the host processor at any time. For example, data associated with the visual feature in the first image may be transmitted (e.g., following block 910, etc.), data associated with the visual feature in the second image may be transmitted (e.g., following block 930, etc.), etc.

Furthermore, it should be understood that the example method 900 may continue in accordance with the techniques discussed herein. For example, following block 970, the method may continue to iterate (e.g., by capturing a fourth image, searching a highest weighted ROI within the fourth image for the visual feature, etc.).

Additionally, it is to be understood that each of the actions described in the example methods 700, 900, may be performed in any order, number of times, or any other suitable combination(s). For example, some or all of the blocks of the methods 700, 900 may be fully performed once or multiple times. In some example implementations, some of the blocks may not be performed while still effecting operations herein. Moreover, the methods 700, 900 are not mutually exclusive, and the blocks may be performed in connection and/or combination with each other in any suitable way.

In addition, in some embodiments, machine learning (e.g., convolutional neural networks, deep learning algorithms, etc.) may be used to analyze ranking data gathered by the imaging system 100. In particular, there are two advantageous implementations of this.

In the first implementation, there is a process plant including a plurality of imaging devices 104. Each of the imaging devices 104 may gather data, and produce a ranking table (e.g., ranking table 800, etc.). The gathered data and/or ranking tables may be analyzed by a machine learning algorithm to create a default ranking table, or default ranked set of ROIs that are used for deployment of future imaging devices 104 throughout the process plant. Advantageously, having such a default ranked set of ROIs improves technical performance of a new imaging device 104 deployed to the processing plant. Specifically, using the default ranked set of ROIs improves processing time over a new imaging device 104 deployed to the processing plant without any adaptive ROI features.

In the second implementation, data from imaging devices 104 of a processing plant is analyzed, and a ranking table that may be used for a plurality of the imaging devices 104 (e.g., all imaging devices 104 in the plant, only imaging devices in a particular section of the plant, only imaging devices capturing information of a particular product, etc.) is developed based on the machine learning analysis.

### ADDITIONAL CONSIDERATIONS

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A method for operating a machine vision system, the machine vision system including a computing device for executing an application and a fixed imaging device communicatively coupled to the computing device, the method comprising:
(a) capturing, via the fixed imaging device, a first image over a field of view (FOV);
(b) analyzing, via the application, at least a portion of the first image to detect a visual feature within the first image;
(c) determining, via the application, a location of the visual feature within the first image;
(d) determining, via the application, a first region of interest (ROI) within the first image based on the location of the visual feature;
(e) capturing, via the fixed imaging device, a second image;
(f) analyzing, via the application, at least a portion of the second image to detect the visual feature within the second image;
(g) determining, via the application, a location of the visual feature within the second image;
(h) determining, via the application, a second ROI within the second image based on the location of the visual feature;
(i) ranking the first and second ROIs;
(j) capturing, via the fixed imaging device, a third image;
(k) analyzing, via the application, a third ROI within the third image to detect the visual feature, the third ROI within the third image being based on the ranking; and
(l) responsive to detecting the visual feature in the third image, transmitting data associated with the visual feature in the third image to a host processor.

2. The method of claim 1, wherein the analyzing the third ROI includes:
setting the third ROI to be a higher ranked ROI from the first ROI and the second ROI;
if the visual feature is determined not to be within the set third ROI, updating the third ROI to be a lower ranked ROI of the first ROI and the second ROI.

3. The method of claim 2, wherein the analyzing the third ROI further includes:
if the visual feature is determined not to be within the updated third ROI, setting the third ROI to be a FOV of the third image.

4. The method of claim 3, wherein the analyzing the third ROI further includes:
analyzing the third ROI that has been set to the FOV of the third image to detect the visual feature;
determining, via the application, a location of the visual feature within the third image;
determining, via the application, a new third ROI within the third image based on the location of the visual feature;
determining, via the application, that the new third ROI is within a predetermined tolerance of the first ROI; and
in response to the determination that the new third ROI is within a predetermined tolerance of the first ROI, incrementing, via the application, a weighting factor of the first ROI.

5. The method of claim 1, further comprising:
subsequent to the analyzing of the ROI of the third image, iteratively capturing images, and, at each iteration:
incrementing a weighting factor of the first ROI if the visual feature is determined to be within the first ROI;
incrementing a weighting factor of the second ROI if the visual feature is determined to be within the second ROI; and
re-ranking the first and second ROIs based on the weighting factors.

6. The method of claim 1, wherein:
the analyzing the at a portion of the first image to detect the visual feature comprises determining, via the application, a bounding box of the visual feature; and
the determining the first ROI within the first image comprises applying a scaling factor to the bounding box.

7. The method of claim 1, further comprising:
responsive to detecting the visual feature in the first image, transmitting data associated with the visual feature in the first image to the host processor; and
responsive to detecting the visual feature in the second image, transmitting data associated with the visual feature in the second image to the host processor.

8. The method of claim 1, wherein the ranking the first and second ROIs comprises:
presenting, to a user, a representation of the first ROI and the second ROI;
receiving, from the user, a user selection of either the first ROI or the second ROI; and
setting the ranks of the first ROI and the second ROI based on the user selection.

9. A method for operating a machine vision system, the machine vision system including a computing device for executing an application and a fixed imaging device communicatively coupled to the computing device, the method comprising:
capturing, via the fixed imaging device, a first plurality of images over a field of view (FOV);
from the first plurality of images, identifying, via the application, a plurality of regions of interest (ROIs) within the FOV, each of the plurality of ROIs being associated with a visual feature, each of the plurality of ROIs being ranked based on a recurrence frequency of the visual feature within a predetermined proximity to each of the ROIs within the plurality of images;
capturing, via the fixed imaging device, a second image;
successively identifying, via the application, a candidate location for the visual feature within the second image based on a rank of each of the ROIs, until the visual feature is identified in the candidate location; and
providing data related to the visual feature from the second image to a host processor.

10. The method of claim 9, wherein the plurality of regions of interest is limited to no more than n ROIs.

11. The method of claim 10, wherein n is specified by a user.

12. The method of claim 9, further comprising:
receiving, from a user, input indicating to disable a ROI feature;
capturing, via the fixed imaging device, a third image; and
in response to receiving the input, setting an ROI within the third image to be the FOV of the third image.

13. The method of claim 9, further comprising:
receiving, from a user, input indicating to disable a ROI feature;
capturing, via the fixed imaging device, a third image;
setting an ROI within the third image based on a highest ranked ROI of the plurality of ROIs;
determining that the feature is not within the ROI within the third image; and
in response to receiving the input and determining that the visual feature is not within the ROI within the third image, setting an ROI within the third image to be the FOV of the third image.

14. The method of claim 9, further comprising:
receiving, from a user, input indicating to disable updating rankings; and
in response to the input, not updating any recurrence frequency of any ROI of the plurality of ROI upon identification of the visual feature within the second image.

15. The method of claim 9, wherein the visual feature is identified in the candidate location based on an entirety of the visual feature being within the candidate location.

16. The method of claim 9, wherein the visual feature is identified in the candidate location based on fifty percent or more of the visual feature being within the candidate location.

17. The method of claim 9, further comprising creating a ranking table including:
ranks of each of the plurality of ROIs;
the recurrence frequency of the visual feature within a predetermined proximity to each of the plurality of ROIs; and
coordinates of each of the plurality of ROIs.

18. The method of claim 9, wherein the visual feature is a barcode.

19. The method of claim 9, wherein the visual feature is a crack on the surface of a structure.
